(19) United States
(12) Patent Application Publication
(10) Pub. No.: US 2013/0017435 A1
(43) Pub. Date: Jan. 17, 2013

(54) LITHIUM ION SECONDARY BATTERY AND ELECTRONIC DEVICE

(71) Applicants: Hiroshi Sato, Niigata (JP); Hiroshi Sasagawa, Niigata (JP); Rieko Kato, Niigata (JP); Tetsu Takahashi, Niigata (JP); Takayuki Fujita, Niigata (JP)

(72) Inventors: Hiroshi Sato, Niigata (JP); Hiroshi Sasagawa, Niigata (JP); Rieko Kato, Niigata (JP); Tetsu Takahashi, Niigata (JP); Takayuki Fujita, Niigata (JP)

(21) Appl. No.: 13/637,772

(22) PCT Filed: Mar. 22, 2011
(86) PCT No.: PCT/JP2011/056766

§ 371 Date: Sep. 27, 2012

(30) Foreign Application Priority Data
Mar. 31, 2010 (JP) 2010-081204

(51) Int. Cl. H01M 4/505; H01M 10/0562; H01M 2/20; H01M 4/525

(52) U.S. Cl. 429/158; 429/224; 429/223; 429/220; 429/221; 429/322

(57) ABSTRACT

Provided is a lithium ion secondary battery including a laminated body formed by laminating a first electrode layer and a second electrode layer on each other via an electrolytic region, wherein the first electrode layer and the second electrode layer include the same active material, and the active material is Li₂MnₓMe₁₋ₓO₃ (Me=Ni, Cu, V, Co, Fe, Ti, Al, Si, or P, and or 0.5£×1).

### TECHNICAL FIELD

The present invention relates to lithium ion secondary batteries in which electrode layers are alternately laminated with solid or liquid electrolytic regions interposed therebetween.

### BACKGROUND ART

With outstanding advancement of electronics technology in recent years, portable electronic devices have been made smaller, lighter, and thinner, and equipped with multiple functions. According to this, batteries as power sources for electronic devices are required to be smaller, lighter, thinner, and highly reliable. In response to the demand, there has been proposed a multilayer lithium ion secondary battery in which a plurality of positive layers and a plurality of negative layers are alternately laminated with solid electrolyte layers interposed therebetween. The multilayer lithium ion secondary battery is assembled by laminating battery cells with a thickness of several tens of micrometers. Therefore, the battery can be readily made smaller, lighter, and thinner. In particular, a parallel or series-parallel laminated battery is excellent in achieving a large discharge capacity with a small cell area. In addition, because an all-solid lithium ion secondary battery includes solid electrolyte instead of electrolytic solution, the all-solid lithium ion secondary battery is immune to leakage or depletion of liquid and has high reliability. Furthermore, because the all-solid lithium ion secondary battery includes lithium, the all-solid lithium ion secondary battery provides high voltage and high energy density.

FIG. 8 is a cross sectional view illustrating a conventional lithium ion secondary battery (Patent Document 1). The conventional lithium ion secondary battery is configured to have a laminated body in which a positive layer 101, a solid electrolyte layer 102, and a negative layer 103 are laminated in sequence; and terminal electrodes 104 and 105 connected electrically to the positive layer 101 and the negative layer 103, respectively. FIG. 8 shows the battery formed by one laminated body for convenience of description. In actuality, however, the battery is generally formed by laminating the large number of positive layers, solid electrolyte layers, and negative layers in sequence to provide a large battery capacity. An active material constituting the positive layers is different from an active material constituting the negative layers. That is, a substance with a higher oxidation-reduction potential is selected as a positive active material, and a substance with a lower oxidation-reduction potential is selected as a negative active material. In the thus structured battery, if the terminal electrode on the negative side is regarded to be under a reference voltage, a positive voltage is applied to the terminal electrode on the positive side to charge the battery. Meanwhile, on discharging, a positive voltage is output from the terminal electrode on the positive side. If the terminal electrode on the positive side is regarded to be under a reference voltage and a positive voltage is applied to the terminal electrode on the negative side (that is the polarities of the terminal electrodes are wrong), the battery is not charged.

In addition, in the case of a secondary battery including liquid electrolyte, it is necessary to strictly comply with guidelines (for example, guidelines on a lower-limit discharge voltage, an upper-limit charge voltage, and the range of operating temperatures) for safety charging. If the guidelines are not followed, an electrode metal is eluted into the electrolyte, and the deposited metal breaks through a separator, and the flaked metal floats in the liquid electrolyte. This may break the battery due to short-circuit and heat generation within the battery. It is extremely dangerous to reversely charge the polarized lithium ion secondary battery including liquid electrolyte because this is equivalent to charging the battery with a voltage under the lower-limit discharge voltage.

From these reasons, all conventional batteries including all-solid batteries and batteries that includes liquid electrolyte bear indication of polarities regardless of the size of battery. In addition, such batteries are checked for correct polarities before placement of the batteries. However, small-sized batteries (in particular with one side of 5 mm or less) are manufactured at a low unit price. Therefore the cost for indicating and checking the polarities of the battery is an extremely burden for the manufacture.

Furthermore, while lithium ion secondary batteries have been increasingly made smaller, there have arisen problems other than manufacturing cost as follows. In particular, in the case of an all-solid small-sized battery manufactured by simultaneous sintering as described in Patent Document 1, it has been extremely technically difficult to place marks on the surface of the battery for identification of positive and negative electrodes. In the case of a secondary battery to be mounted on an electronic circuit board (for example, a chip-type lithium ion secondary battery), even if the marks are incorrectly placed on the battery, it is not possible to easily remove the marks and re-place the same on the battery.

### PRIOR ART DOCUMENTS

### Patent documents

### Patent Document 1. WO/2008/099508

### Patent Document 2: JP-A-2007-258165

### Patent Document 3: JP-A-2008-235260

### Patent Document 4: JP-A-2009-211965

### SUMMARY OF THE INVENTION

### Problems to be Solved by the Invention

An object of the present invention is to simplify the process of manufacturing a lithium ion secondary battery and reduce manufacturing cost thereof.

### Solutions to the Problems

The present invention (1) is a lithium ion secondary battery in which a first electrode layer and a second electrode layer are laminated on each other via an electrolytic region, wherein the first electrode layer and the second electrode layer include the same active material, and the active material is Li₂MnO₃.

The present invention (2) is the lithium ion secondary battery according to the invention (1), wherein a material constituting the electrolytic region is an inorganic solid electrolyte.

The present invention (3) is the lithium ion secondary battery according to the invention (2), wherein a material constituting the electrolytic region is ceramic including at least lithium, phosphorus, and silicon.

The present invention (4) is the lithium ion secondary battery according to any one of the inventions (1) to (3), wherein a laminated body in which the first electrode layer and the second electrode layer are laminated via the electrolytic region, is formed by sintering.

The present invention (5) is the lithium ion secondary battery according to the invention (1), wherein a material constituting the electrolytic region is liquid electrolyte.

The present invention (6) is the lithium ion secondary battery according to any one of the inventions (1) to (5), wherein the lithium ion secondary battery is a series or series-parallel battery in which a conductor layer is arranged between adjacent battery cells.

The present invention (7) is an electronic device using the lithium ion secondary battery according to any one of the inventions (1) to (6) as a power source.

The present invention (8) is an electronic device using the lithium ion secondary battery according to any one of the inventions (1) to (6) as a power storage element.

### Effects of the Invention

According to the present inventions (1) to (6), a nonpolar lithium ion battery can be realized. Therefore, it is not necessary to discriminate the terminal polarities. This makes it possible to simplify the battery manufacturing process and placement process, which is effective in manufacturing cost reduction. In particular, in the case of a battery with all of length, width and height of 5 mm or less, a remarkable effect on manufacturing cost reduction can be obtained by eliminating. the step for making polarity identification. In addition, a significantly large battery capacity can be obtained as compared with an MLCC as a nonpolar power source.

According to the present invention (5), it is possible to provide a lithium ion secondary battery including liquid electrolyte with a large margin of a condition for safety charging with no risk of reverse charging.

According to the present invention (7), it is possible to use a battery with lower cost and smaller size as compared with a conventional battery, which is effective in downsizing and cost reduction of an electronic device.

According to the present invention (8), because a lithium ion secondary battery can be used as a large-capacity storage element, a degree of freedom for circuit designing is improved. For example, a lithium ion secondary battery with a large storage density is connected between an AC/DC converter or DC/DC converter for power supply and a load device. This allows the lithium ion secondary battery to function as a smoothing capacitor. As a result, it is possible to supply stable electric power with low ripple to the load device and reduce the number of parts.

### BRIEF DESCRIPTION OF THE DRAWINGS

FIG. 1 is a cross sectional view illustrating a conceptual structure of a lithium ion secondary battery according to one example of an embodiment of the present invention.

FIGS. 2(a) to 2(d) are cross sectional views illustrating lithium ion secondary batteries according to other examples of an embodiment of the present invention.

FIGS. 3(a) and 3(h) are cross sectional views illustrating lithium ion secondary batteries according to other examples of an embodiment of the present invention.

FIG. 4 is graphs of inter-terminal voltage of a battery with Li₂MnO₃ for a positive electrode and Li for a negative electrode on charging and discharging.

FIG. 5 shows charge-discharge curves and cycle characteristics of a lithium ion wet secondary battery with Li₂MnO₃ for both electrodes according to an embodiment of the present invention.

FIG. 6 shows cycle characteristics of ail-solid lithium ion secondary batteries according to examples of the present invention.

FIG. 7 shows charge-discharge curves of all-solid lithium ion secondary batteries according to the examples of the present invention.

FIG. 8 is a cross sectional view illustrating a conventional lithium ion secondary battery.

### DESCRIPTION OF REFERENCE SIGNS

1 and 3 Active material layer in first electrode layer

2 Mixed layer of active material and current collector in first electrode layer

4 Electrolytic region

5 Second terminal electrode

6 First terminal electrode

7 and 9 Active material layer in second electrode layer

8 Mixed layer of active material and current collector in second electrode layer

21, 30, 37, and 44 Electrolytic region

22, 27, and 29 Active material layer in first electrode layer

23, 33, and 35 Active material layer in second electrode layer

24, 31, 39, and 48 Second terminal electrode

25, 32, 40, and 49 First terminal electrode

28, 34, 42, and 46 Current collector layer

36 Mixed layer of active material and current collector in first electrode layer

38 Mixed layer of active material and current collector in second electrode layer

41 and 43 Mixed layer of active material and solid electrolyte in first electrode layer

45 and 47 Mixed layer of active material and solid electrolyte in first electrode layer

61, 65, and 69 Current collector layer

62, 64, 66, and 68 Active material layer

63 and 67 Electrolytic region

70, 78, and 86 Current collector layer

71, 77, 79, and 85 Mixed layer of active material and current collector

72, 76, 80, and 84 Active material layer

73, 75, 81, and 83 Mixed layer of active material and solid electrolyte

74 and 82 Electrolytic region

101 Positive layer

102 Solid electrolyte layer

103 Negative layer

104 and 105 Terminal electrode

### DESCRIPTION OF EMBODIMENTS

A best embodiment of the present invention will be described below,

The inventors of the present application presumed that using the same active material for positive and negative electrodes makes it possible to use a battery without the need for identifying the polarities of terminals of the battery, eliminate checking of the battery polarity, and simplify the process of manufacturing the battery. Hereinafter, a secondary battery not requiring identification of positive and negative electrodes will be referred to as “nonpolar secondary battery.”

Means for realization of a nonpolar secondary battery includes a laminated ceramic capacitor (MLCC). According to its power storage principal, because the MLCC has terminal electrodes with no polarity, the electrode charged at a higher potential operates as a positive electrode and the electrode charged at a lower potential operates as a negative electrode. The MLCC can be mounted on an electronic substrate without the need for paying attention to the direction of mounting. However, the MLCC has a following problem. That is, because the MLCC stores electric power with polarization of a dielectric body, the MLCC has an extremely lower amount of stored power per unit volume than that of a power storage element with a chemical reaction (for example, a lithium ion secondary battery).

The inventors of the present application studied realization of a nonpolar battery by a lithium ion secondary battery. In particular, the inventors earnestly examined an active material effective in realization of a nonpolar battery. As a result, the inventors found that Li₂MnO₃ is useful as an active material for a nonpolar lithium ion secondary battery for the first time. The composite oxide functions as a positive active material of a lithium ion secondary battery that releases lithium ions to the outside of its structure according to an applied voltage. In addition, the composite oxide also functions as a negative active material because the composite oxide has a site for taking lithium ions into its structure. Here, having both the lithium ion releasability and the lithium ion absorbability means that, if the same active material is used for the positive and negative electrodes of a secondary battery, the active material exhibits both the lithium ion releasability and the lithium ion absorbability.

In the case of using Li₂MnO₃, any of the following reactions can occur:

| | |
|---|---|
| Li₍₂₋ₓ₎MnO₃ ← Li₂MnO₃ | Li release (charge) reaction |
| Li₍₂₋ₓ₎MnO₃ → Li₂MnO₃ | Li absorption (discharge) reaction |
| Li₂MnO₃ → Li₍₂₊ₓ₎MnO₃ | Li absorption (discharge) reaction |
| Li₂MnO₃ ← Li₍₂₊ₓ₎MnO₃ | Li release (charge) reaction |
| (0 < x < 2) | |

Therefore, Li₂MnO₃ can be used as an active material for both electrodes of a nonpolar battery. It can be said that Li₂MnO₃ has both the lithium ion releasability and the lithium ion absorbability.

On the other hand, in the case of using LiCoO₂, the following reactions can occur:

| | |
|---|---|
| Li₍₁₋ₓ₎CoO₂ ← LiCoO₂ | Li release (charge) reaction |
| Li₍₁₋ₓ₎CoO₂ → LiCoO₂ | Li absorption (discharge) reaction |
| (0 < x < 1) | |

However, the following reactions cannot occur:

| | |
|---|---|
| LiCoO₂ → Li₍₁₊ₓ₎CoO₂ | Li absorption (discharge) reaction |
| LiCoO₂ ← Li₍₁₊ₓ₎CoO₂ | Li release (charge) reaction |
| (0 < x < 1) | |

Therefore, LiCoO₂ cannot be used as an active material for both electrodes of a nonpolar battery. It cannot be said that LiCoO₂ has both the lithium ion releasability and the lithium ion absorbability.

In addition, in the case of using Li₄Ti₅O₁₂, for example, the following reactions can occur:

| | |
|---|---|
| Li₄Ti₅O₁₂ → Li₍₄₊ₓ₎Ti₅O₁₂ | Li absorption (discharge) reaction |
| Li₄Ti₅O₁₂ ← Li₍₄₊ₓ₎Ti₅O₁₂ | Li release (charge) reaction |
| (0 < x < 1) | |

However, the following reactions cannot occur:

| | |
|---|---|
| Li₍₄₋ₓ₎Ti₅O₁₂ ← Li₄Ti₅O₁₂ | Li release (discharge) reaction |
| Li₍₄₋ₓ₎Ti₅O₁₂ → Li₄Ti₅O₁₂ | Li absorption (discharge) reaction |
| (0 < x < 1) | |

Therefore, Li₄Ti₅O₁₂ cannot he used as an active material for both electrodes of a nonpolar battery. It cannot be said that Li₄Ti₅O₁₂ has both the lithium ion releasability and the lithium ion absorbability,

Conditions for an active material to have both the functions as a positive active material and a negative active material include: (a) the active material includes lithium in its structure; (b) the active material has a lithium ion dispersing path in its structure; (c) the active material has a site for absorbing lithium ions in its structure; (d) the average valence of a base metal element constituting the active material can be higher or lower than a valence on synthesis of the active material; and (e) the active material has moderate electron conductivity. The active material used in the present invention can be any of active materials that meet the foregoing conditions (a) to (e). An example of an active material that meets the conditions is Li₂MnO₃. However, not limited to these materials, any active materials in which a part of Mn of Li₂MnO₃ is substituted by metal other than Mn meet the foregoing conditions (a) to (e). Therefore, it is needless to say that such an active material can be suitably used as an active material for a lithium ion secondary battery according to the present invention, Furthermore, for manufacture of an all-solid battery, the active material preferably exhibits sufficiently high heat resistance in simultaneous sintering.

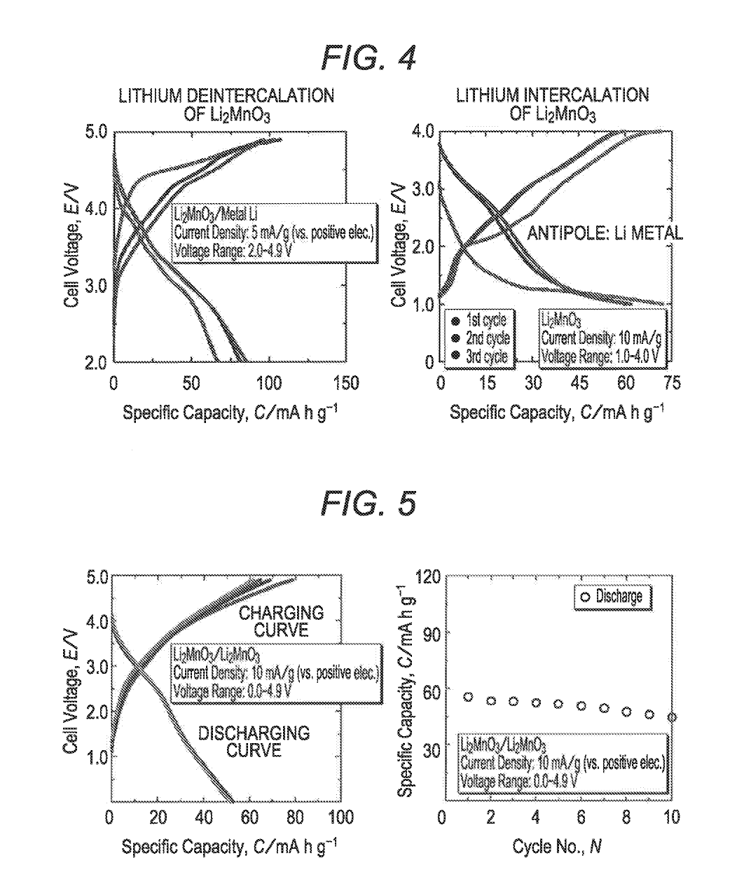

FIG. 4 is graphs of inter-terminal voltage of a wet battery on charging and inter-terminal voltage of the wet battery on discharging, where the wet battery includes Li₂MnO₃ as a positive material, Li as a negative material, and organic electrolytic. solution as electrolyte. On charging, the inter-terminal voltage increases from about 3 V to 4.9 V over time. On the other hand, on discharging, the inter-terminal voltage decreases from about 3 V to 1 V over time. From this, it is understood that, if a battery is prepared using Li₂MnO₃ for both positive and negative electrodes and this battery is charged, lithium ions are deintercalated from Li₂MnO₃ of the electrode applied positively (+) by a charger into the electrolyte, and at the same time, lithium ions having passed through the electrolyte are intercalated to Li₂MnO₃ of the electrode applied negatively (−), whereby the battery functions as a battery.

### (Structure of a Battery)

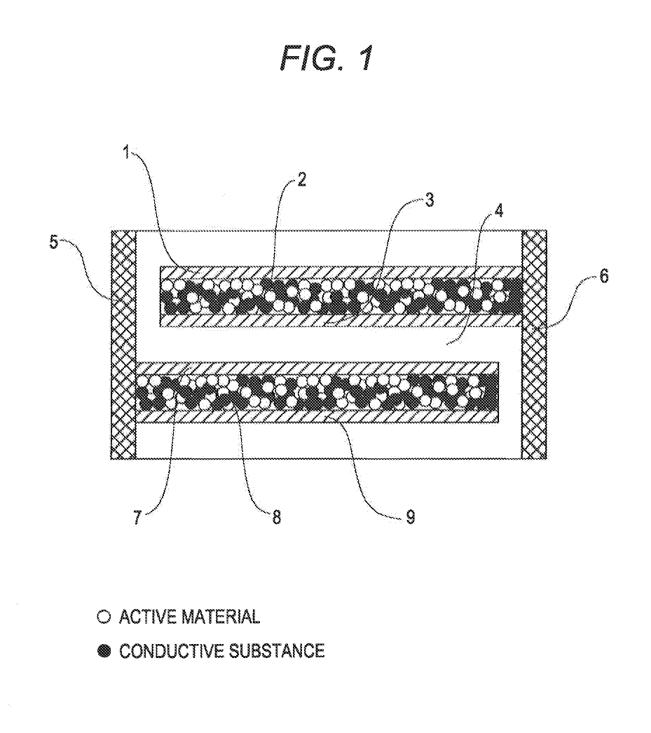

FIG. 1 is a cross sectional view illustrating a conceptual structure of a lithium ion secondary battery according to one example of an embodiment of the present invention. The lithium ion secondary battery illustrated in FIG. 1 includes: active material layers 1 and 3; a first electrode layer formed by a mixed layer 2 of an active material and a current collector; and a second electrode layer formed by active material layers 7 and 9 and a mixed layer 8 of an active material and a current collector. These layers are alternately laminated with an electrolytic region 2 interposed therebetween. In addition, the first electrode layer and the second electrode layer include the same active material. The active material has both the lithium ion releasability and the lithium ion absorbability. The first electrode layer is electrically connected to a terminal electrode 5 at the right end. The second electrode layer is electrically connected to a terminal electrode 4 at the left end. Of these electrodes, the electrode charged at a relatively positive potential functions as a positive electrode on discharging. The material constituting the electrolytic region 2 may be solid electrolyte or liquid electrolyte.

Here, the first and second electrode layers may be configured in the following manner, for example:

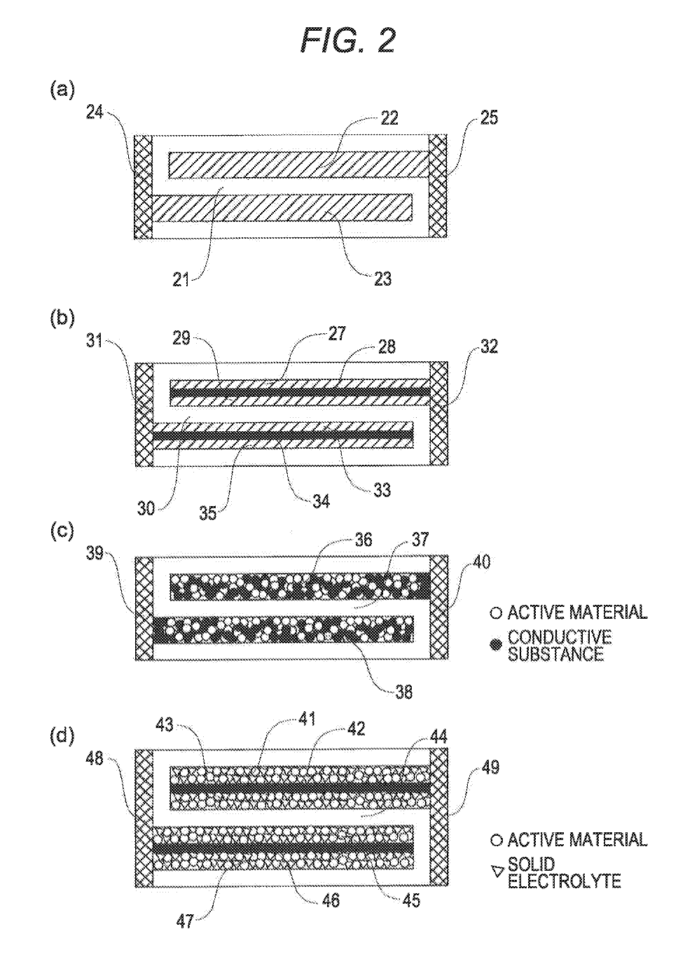

(1) Structure Including a Layer made of an Active Material (FIG. 2(a))

That is, each of the first and second electrode layers in this example has a single active material layer structure made of an active material. The active material layer is not a mixed layer of a conductive substance and solid electrolyte.

(2.) Structure in which a Layer Formed by a Mixture of an Active Material and a Conductive Substance is Sandwiched Between Layers made of an Active Material (FIG. 1)

In this case, the layer formed by a mixture (mixture layer) functions as a current collector. The mixture layer may have a structure in which particles of a conductive substance and particles of an active material are simply mixed (for example, no surface reaction or dispersion takes place between these materials). However, the mixture layer preferably has a structure in which an active material is held by a conductive matrix of a conductive substance. The same active material is used for the first and second electrode layers. The conductive substance preferably includes the same material as that of these layers. In addition, the first and second electrode layers preferably have the same mixture ratio of an active material and a conductive substance. Furthermore, the active material layer and the mixture layer are substantially the same in thickness between the first and second electrode layers.

(3) Structure Formed by a Layer of a Mixture of an Active Material and a Conductive Substance (FIG. 2(c))

The mixture layer may have a structure in which particles of a conductive substance and particles of an active material are simply mixed (for example, no surface reaction or dispersion takes place between these materials). However, the mixture layer preferably has a structure in which an active material is held by a conductive matrix of a conductive substance. The same active material is used for the first and second electrode layers. In this case, the conductive substance preferably includes the same material as that of these layers. In addition, the first and second electrode layers preferably have the same mixture ratio of an active material and a conductive substance.

(4) Structure in which a Conductive Substance Layer Formed by a Conductive Substance is Sandwiched Between a Mixture Layer Formed by a Mixture of an Active Material and Solid Electrolyte (FIG. 2(d))

In this case, the mixture layer may have a structure in which particles of solid electrolyte and particles of an active material are simply mixed (for example, no surface reaction or dispersion takes place between these materials). However, the mixture layer preferably has a structure in which an active material is held by a matrix of solid electrolyte. The same active material is used for the first and second electrode layers. Similarly, the solid electrolyte preferably includes the same material as that of these layers. In addition, the first and second electrode layers preferably have the same mixture ratio of an active material and solid electrolyte.

(5) Structure in which a Conductive Substance Layer made of a Conductive Substance is Sandwiched Between Active Material Layers (FIG. 2(h))

The same active material is used for the first and second electrode layers. The conductive substance preferably includes the same material as that of these layers.

A laminated body in which a positive electrode layer and a negative electrode layer are laminated with a solid electrolyte layer interposed therebetween is set as one battery cell. In this case, FIGS. 1 and 2(a) to 2(d) each illustrate a cross sectional view of a battery in which one battery cell is laminated. However, the technique for a lithium ion secondary battery of the present invention is applicable not only to a battery in which one battery cell is laminated as illustrated but also to a battery in which an arbitrary number of layers is laminated. In addition, the number of the battery cells can vary widely depending on required capacity and current specification of a lithium ion secondary battery. For example, a battery with 2 to 500 battery cells is manufactured as a practical battery,

Lithium ion secondary batteries according to other examples of the present invention illustrated in FIG. 2 will be described in detail below.

FIG. 2(b) is a cross sectional view illustrating a battery. To reduce internal resistance of an electrode layer, a conductive substance layer (current collector layer) 28 is formed in parallel with active material layers 27 and 29. In addition, a conductive substance layer (current collector layer) 34 is formed in parallel with active material layers 33 and 35. The current collector layers are made of a material with high conductivity (for example, metallic paste).

Similarly, FIG. 2(c) is a cross sectional view illustrating a battery having a structure intended to reduce internal resistance of an electrode layer. In a laminated body constituting the battery, a mixture layer 36 formed by a mixture of an active material and a conductive substance and a mixture layer 38 formed by a mixture of an active material and a conductive substance are alternately laminated with an electrolytic region 37 interposed therebetween.

FIG. 2(d) is a cross sectional view illustrating a battery having a structure intended to realize a large capacity of the battery. In a laminated body constituting the battery, a first electrode layer including a current collector layer 42 and mixture layers 41 and 43 of an active material and solid electrolyte and a second electrode layer including a current collector layer 46 and mixture layers 45 and 47 of an active material and solid electrolyte are alternately laminated with an electrolytic region 44 interposed therebetween. The material constituting the electrolytic region 44 is preferably the same as that for the solid electrolyte constituting the first and second electrode layers. Because the electrode layers have large areas that are in contact with the active material and the solid electrolyte, a large capacity of the battery is realized. The current collector layers 42 and 46 are arranged in parallel with the electrode layers. Such an arrangement is not necessarily required to realize a lithium ion secondary battery of the present invention intended to reduce internal resistance of the battery, as with the battery illustrated in FIG. 2(h).

### (Structure of a Series Battery)

Each of the batteries described above with reference to FIGS. 1 and 2 is a parallel battery in which each of a plurality of battery cells constituting the battery is connected in parallel with each other. However, it is needless to say that the technical idea of the present invention is not limited to parallel batteries, but is also applicable to series batteries and series-parallel batteries and excellent advantages can be obtained.

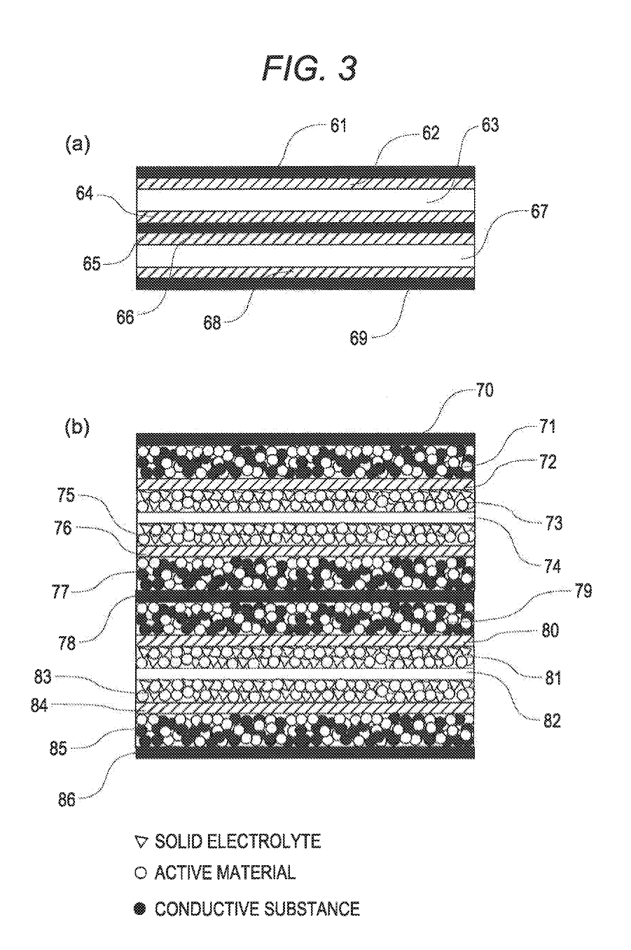

FIGS. 3(a) and 3(b) are cross sectional views illustrating lithium ion secondary batteries according to other examples of an embodiment of the present invention. FIG. 3(a) illustrates a battery in which two battery cells are connected in series. The battery shown in FIG. 3(a) is formed by laminating a current collector layer 69, an active material layer 68, an electrolytic region 67, an active material layer 66, a current collector layer 65, an active material layer 64, an electrolytic region 63, an active material layer 62, and a current collector layer 61 in sequence. An excellent nonpolar battery can be formed by the use of the same preferable active material described herein for constituting the active material layers. In the series battery, unlike the parallel battery, it is necessary to isolate the battery cells by a lithium ion movement inhibitor layer, so as to prevent lithium ions from moving between the different battery cells. The lithium ion movement inhibitor layer may be any layer including no active material or electrolyte. In the battery illustrated in FIG. 3(a), the current collector layers function as the lithium ion movement inhibitor layer.

FIG. 3(h) illustrates another example of a series lithium ion secondary battery. The battery is structured in such a manner that three electrode layers are arranged, a layer adjacent to an electrolytic region is configured as a mixture layer of an active material and solid electrolyte to realize a large capacity of the battery, and a layer adjacent to a current collector layer is configured as a mixture layer of an active material and a conductive substance to realize reduction in internal resistance of the battery.

In the series batteries exemplified in FIGS. 3(a) and 3(b), it is needless to say that the material constituting the electrolytic regions may be solid electrolyte or liquid electrolyte.

### (Definitions of Terms)

As described above with reference to the drawings, “electrode layer” described herein refers to one of the followings:

(1) Active material layer including active material only;
(2) Mixture layer including active material and conductive substance;
(3) Mixture layer including active material and solid electrolyte; and
(4) Laminated body in which the foregoing layers (1) to (3) (a single layer or combination thereof) and current collector layer are laminated.

### (Material for Battery)

### (Material for Active Material)

The active material constituting the electrode layer of the lithium ion secondary battery of the present invention is preferably a material that efficiently release or absorb lithium ions. For example, a transition metal element constituting the active material preferably varies in multi-valence. For example, the active material is preferably Li₂MnO₃. Alternatively, the active material is preferably Li₂MnₓMe₁₋ₓO₃ (Me=Ni, Cu, V, Co, Fe, Ti, Al, Si, or P, 0.5≦×<1) in which a part of Mn is substituted by another transition metal element. The active material is preferably one or more materials selected from the foregoing group of substances.

### (Material for Conductive Substance)

The conductive substance constituting the electrode layer of the lithium ion secondary battery of the present invention is preferably a material with high conductivity. For example, the conductive substance is preferably a metal or an alloy with high oxidation resistance. The metal or the alloy with high oxidation resistance here refers to a metal or an alloy having a conductivity of 1×10¹S/cm or more after being sintered under ambient atmosphere. Specifically, preferable examples of metals to be used include silver, palladium, gold, platinum, and aluminum. Preferable examples of alloys to be used include alloys including two or more metals selected from silver, palladium, gold, platinum, copper, and aluminum. For example, AgPd is preferably used. AgPd is preferably mixed powder of Ag powder and Pd powder, or AgPd alloy powder,

The mixture ratio of an active material and a material for a conductive substance to be mixed with the active material for preparing the electrode layer may be different between opposite electrodes. However, the mixture ratio is preferably the same between opposite electrodes to make a nonpolar battery by matching constriction behaviors on simultaneous sintering and physical properties.

### (Material for Solid Electrolyte)

The solid electrolyte constituting the solid electrolyte layer of the lithium ion secondary battery of the present invention is preferably a material with low electronic conductivity and high lithium ion conductivity. In addition, the solid electrolyte is preferably an inorganic material that can be sintered at a high temperature under ambient atmosphere. For example, such the inorganic material is preferably at least one kind of a material selected from the group consisting of: oxide including lithium, lanthanum, and titanium; oxide including lithium, lanthanum, tantalum, barium, and titanium; polyanion oxide not including a multivalent transition element including lithium; polyanion oxide including lithium, a representative element, and at least one kind of a transition element; lithium silicon phosphate (Li_{3.5}Si_{0.5}P_{0.5}O₄); lithium titanium phosphate (LiTi₂(PO₄)₂); lithium germanium phosphate (LiGe₂(PO₄)₃); Li₂-SiO₂; Li₂O-V₂O₅-SiO₂; Li₂-P₂O₅B₂O₃; and Li₂O-GeO₂. In addition, the material for the solid electrolyte layer is preferably ceramic including at least lithium, phosphorus, and silicon. Furthermore, the material for the solid electrolyte layer may be any of these materials doped with a different kind of element or Li₃PO₄, LiPO₃, Li₄SiO₄, Li₂SiO₃, LiBO₂, or the like. In addition, the material for the solid electrolyte layer may be a crystalline material, an amorphous material, or a glass material.

### (Method of Manufacturing Battery)

The lithium ion secondary battery of the present invention is preferably manufactured by sequentially performing the following steps of:

(1) Dispersing a predetermined active material and conductive metal into a vehicle including an organic binder, a solvent, a coupling agent, and a dispersing agent to obtain an active material-mixed current collector electrode paste;
(2) Dispersing a predetermined active material into a vehicle including an organic binder, a solvent, a coupling agent, and a dispersing agent to obtain an active material paste;
(3) Dispersing inorganic solid electrolyte into a vehicle including an organic binder, a solvent, a coupling agent, and a dispersing agent to obtain an inorganic solid electrolyte slip;
(4) Applying the inorganic solid electrolyte slip on a base material and then drying the base material to obtain an inorganic, solid electrolyte thin-layer sheet;
(5) Printing the active material paste and the current collector electrode paste on the inorganic solid electrolyte sheet, and drying the same;
(6) Laminating the printed sheet obtained at the step (5);
(7) Cutting the laminated body obtained at the step (6) as appropriate and sintering the same; and
(8) Attaching a terminal electrode to the laminated body obtained at the step (7).

A preferable specific example of a method of manufacturing the lithium ion secondary battery of the present invention will be shown below. However, the method of manufacturing the lithium ion secondary battery of the present invention is not limited to the method described below.

### (Step of Preparing Active Material Paste)

The active material paste is prepared as described below. Predetermined active material powder is pulverized by a dry grinding mill/wet grinding mill to a particle size suitable for an all-solid secondary battery. After that, the active material powder is dispersed into an organic binder or a solvent by a disperser such as a planetary mixer or a triple roll mill. A coupling agent or a dispersing agent may be added as appropriate to allow for preferable dispersion of the active material into the organic binder. The dispersing method to he used in the present invention is not limited to the foregoing method. The dispersing method may be any of the methods that realize high dispersion without aggregation of the active material in the paste and interference with printing on the solid electrolyte sheet. Furthermore, viscosity of the paste to be used in the present invention is preferably adjusted by adding a solvent as appropriate to allow for preferable printing performance. Moreover, an auxiliary conductive material, a rheology adjustment agent, or the like may be added to the paste as appropriate, according to the required battery performance.

### (Step of Preparing Active Material-Mixed Current Collector Electrode Paste)

The active material-mixed current collector electrode paste is prepared as described below. Predetermined active material powder is pulverized by a dry grinding mill/wet grinding mill to a particle size suitable for an all-solid secondary battery. After that, the active material powder is mixed with metallic powder to be a current collector electrode. The mixture is dispersed into an organic binder or a solvent by a disperser such as a planetary mixer or a triple roll mill. A coupling agent and a dispersing agent may be added as appropriate to allow for favorable dispersion of the active material into the organic binder. The dispersing method to be used in the present invention is not limited to the foregoing method. The dispersing method may be any of methods that realize high dispersion without aggregation of the active material in the paste and interference with printing on the solid electrolyte sheet. Furthermore, viscosity of the paste to be used in the present invention is preferably adjusted by adding a solvent as appropriate to allow for preferable printing performance. Moreover, an auxiliary conductive material, a rheology adjustment agent, or the like may be added to the paste as appropriate, according to the required battery performance.

### (Step of Preparing Inorganic Solid Electrolyte Sheet)

The inorganic solid electrolyte thin-layer sheet is prepared as described below, inorganic solid electrolyte powder is pulverized by a dry grinding mill/wet grinding mill to a particle size suitable for an all-solid secondary battery. After that, the inorganic solid electrolyte powder is mixed with an organic binder or a solvent, and then is dispersed by a wet grinding mill such as a pot mill or a bead mill, to obtain an inorganic solid electrolyte slip. The obtained inorganic solid electrolyte slip is lightly applied on a base material such as a pet film by a doctor blade method or the like. After that, the inorganic solid electrolyte slip is dried to evaporate the solvent. As a result, the inorganic solid electrolyte thin-layer sheet can be obtained on the base material. A coupling agent or a dispersing agent may be added as appropriate to allow for preferable dispersion of the inorganic solid electrolyte powder into the organic binder. The dispersing method to he used in the present invention is not limited to the foregoing method. The dispersing method may be any of methods that realize high dispersion without aggregation of the inorganic solid electrolyte powder in the inorganic solid electrolyte sheet and on a surface thereof, and interference with printing on the inorganic solid electrolyte sheet.

### (Step of Printing Active Material Paste and Active Material-Mixed Electrode Paste on Inorganic Solid Electrolyte)

The active material paste, the active material-mixed current collector electrode paste, and the active material paste are sequentially printed on top of one another on the thus obtained inorganic solid electrolyte sheet, and then the sheet is dried, to obtain an active material-printed inorganic solid electrolyte sheet. Each of the pastes may be dried after each application in the printing of the active material pastes onto the inorganic solid electrolyte sheet. Alternatively, the active material pastes may be dried after the three layers of the active material paste, active material-mixed paste, and active material paste are printed. Examples of printing methods include screen printing and inkjet printing. However, in the case of screen printing, the former printing/drying step is preferred. In the case of inkjet printing, the latter printing/dying step is preferred. In the latter printing/drying step, after the active material paste is printed on the inorganic solid electrolyte, the active material-mixed current collector electrode paste is printed without drying the active material paste. As a result, it is possible to more favorably form a junction between a printing interface of the active material paste and a printing interface of the active material-mixed current collector electrode paste.

### (Handling of End Faces of Battery)

A printing end face of the active material paste and a printing end face of the active material-mixed current collector electrode paste, or a printing end face of the active material-mixed current collector electrode paste, is printed so as to extend to any of end faces of the inorganic solid electrolyte sheet. Alternatively, the inorganic solid electrolyte sheet in which the active material and the active material-mixed current collector paste are laminated and printed is separated from the base material, and the separated sheets are further laminated and pressed, and then the obtained laminated body is cut out to obtain predetermined end faces.

### (Step of Sintering Laminated Body)

The obtained laminated body is sintered to obtain a desired nonpolar lithium ion secondary battery. Conditions for sintering are selected as appropriate according to the kinds of an active material paste, an active material-mixed current collector electrode paste, an organic binder included in an inorganic solid electrolyte slip, a solvent, a coupling agent, and a dispersing agent, the kind of an active material included in the active material paste, and the kind of a metal used for the active material-mixed current collector electrode paste. An undegraded organic matter in the sintering step may cause separation of the laminated body after the sintering and contribute to a short-circuit in the battery due to residual carbon. In particular, if the laminated body is to be sintered under an atmosphere not including oxygen, it is preferred to introduce water vapor to facilitate oxidation of the organic matter, to minimize residual carbon within the battery.

### (Addition of Fusing Agent)

To match sintering behaviors of the active material, the current collector metal, and the inorganic solid electrolyte in the layers constituting the laminated body or to allow for low-temperature sintering, a fusing agent for facilitating sintering may be added to the active material paste, the active material-mixed current collector electrode paste, and the inorganic solid electrolyte slip. The fusing agent may be added in advance on synthesizing the active material powder or the inorganic solid electrolyte from raw material powder, or the fusing agent may be added in the step of dispersing the synthesized active material or inorganic solid electrolyte into an organic binder, a solvent, or the like.

### (Step of Preparing Terminal Electrode)

A terminal electrode may be prepared by a method in which a thermosetting conductive paste is applied to an electrode end face of an all-solid secondary battery obtained by sintering a laminated body green and the applied paste is hardened; a method in which a baking metal-containing paste is applied to the electrode end thee and then the paste is formed into a sintered body by sintering; a method in which plating is used; a method in which soldering is used after plating; a method in which a solder paste is applied and heated; and the like. However, as the simplest method, the terminal electrode is preferably formed by applying and hardening a thermosetting conductive paste.

(Difference from Similar Prior Art)

Patent Document 2 describes an all-solid battery that includes a material including polyanion for all of active materials and solid electrolyte. According to only the claims of Patent Document 2, there exists a combination of the same positive active material and negative active material. However, the battery described in Patent Document 2 is intended to realize higher power output, longer lifetime, improved safety, and reduced cost of the battery, not to unpolarize the battery. In actuality, Patent Document 2 describes a battery including different active materials for positive and negative electrodes (that is, a battery that cannot be used as a nonpolar battery) in an embodiment. Therefore, it is not possible to easily contrive a lithium ion secondary battery that includes the same active material for positive and negative electrodes for the purpose of unpolarization according to the present invention, from the description of Patent Document 2.

Patent Document 3 describes a wet battery including liquid electrolyte and the same active material for opposite electrodes. The same active material is used for the opposite electrodes to set a difference in potential between the active materials at production to 0, thereby preventing electrolysis of the electrolytic solution. That is, the wet battery described in Patent Document 3 is devised to reduce risk of burst and ignition due to gas generated by electrolysis of the electrolytic solution. Accordingly, the battery described in Patent Document 3 is also intended to realize storage stability of the battery, not to unpolarize the battery. In addition, Patent Document 3 does not describe any active material suitable for a high-performance nonpolar battery. The battery of an example described in Patent Document 3 has a discharge starting voltage of 2.8 V. On the other hand, because the battery that includes LiNnO₃ according to an example of the present invention as an active material can start discharging at 4 V, the battery with high voltage (high energy density) can be manufactured. In addition, Patent Document 3 describes in an example a coin-type battery with a diameter of more than ten mm in which structures of positive and negative electrodes are asymmetry. Accordingly, it is not possible to easily contrive a lithium ion secondary battery that includes the same active material for positive and negative electrodes from the description of Patent Document 3, for the purpose of unpolarization according to the present invention.

Patent Document 4 discloses a nonpolar lithium ion secondary battery in which an active material for opposite electrodes of the battery includes Li₂FeS₂. The active material Li₂FeS₂ described in Patent Document 4 also has both the lithium ion releasability and the lithium ion absorbability. However, this substance has many problems as a material for a battery, unlike Li₂MnO₃, which is the active material according to the present invention. For example, Li₂FeS₂ has high material reactivity, as described in Patent Document 4, paragraph [0036]. Accordingly, because Li₂FeS₂ cannot be synthesized in the atmosphere, Li₂FeS₂ is synthesized by vacuum heating. Therefore, it is necessary to use a vacuum device in manufacturing equipment, which results in increase of manufacturing cost. Similarly, Li₂FeS₂ does not allow for simultaneous sintering of a laminated body in the atmosphere. In addition, because Li₂Fes₂ is a sulfide, Li₂FeS₂ reacts with water in the atmosphere to generate hydrogen sulfide. Accordingly, it is necessary to provide an outer can around the battery for sealing, which makes it difficult to downsize the battery. In contrast to this, Li₂MnO₃, which is the active material according to the present invention, allows for synthesis of an active material and simultaneous sintering of a laminated body for the battery in the atmosphere. Therefore, manufacturing cost is low. In addition, Li₂MnO₃ makes it possible to manufacture the battery in a manufacturing process of an existing laminated ceramic capacitor or the like.

(Applications of Battery to Purpose Other than Power Source)

The lithium ion secondary battery according to the present invention can be used in applications other than power source. A possible factor behind that is a problem of increase in power source wiring resistance due to decrease in wire width associated with reduction in size and weight of electronic devices. For example, when electric power consumed by a CPU of a notebook personal computer increases, a power supply voltage supplied to the CPU becomes under a minimum drive voltage if a power source wiring resistance is high, which may cause a problem such as a signal processing error or crash. Accordingly, a power storage element formed by a smoothing capacitor is disposed between a power supply device such as an AC/DC converter or a DC/DC converter and a load device such as a CPU to suppress ripple in a power supply line. This allows constant power to be supplied to the load device even if there is a temporary reduction in power supply voltage. However, power storage elements such as an aluminum electrolytic capacitor and a tantalum electrolytic capacitor, are based on a power storage principle that a dielectric body is polarized. Therefore, these power storage elements have a drawback of small power storage density. In addition, these power storage elements include electrolytic solution. This makes it difficult to mount these elements near a component on a substrate by solder reflow.

In contrast to this, the lithium ion secondary battery according to the present invention can be mounted in the proximity of a component (load device) on a substrate. In particular, if the lithium ion secondary battery according to the present invention is mounted close to a component with high power consumption and is used as a power storage element, the battery can function as a power storage device to a maximum extent. Furthermore, because the lithium ion secondary battery according to the present invention is an extremely small-sized nonpolar battery, the lithium ion secondary battery can be easily attached to a mounting board. In particular, the battery that includes inorganic solid electrolyte has high heat resistance and can be mounted by solder reflow. In addition, because the lithium ion secondary battery is based on a power storage principle that lithium ions move between electrodes, the lithium ion secondary battery has a high power storage density. Accordingly, when being used as a power storage element, the nonpolar lithium ion secondary battery can function as an excellent smoothing capacitor and/or a backup power source. As a result, stable power can be supplied to the load device. Furthermore, it is possible to provide advantages of improving the degree of freedom for designing a circuit and a mounting board, and reducing the number of parts.

### EXAMPLES

### Example 1

The present invention will be described in detail below with reference to examples. However, the present invention is not limited to these examples. In the following description, indications of “part” refer to part by weight unless otherwise specified.

### (Preparation of Active Material)

Li₂MnO₃ prepared by a method described below was used as an active material.

Specifically, Li₂CO₃ and MnCO₃ as starting materials, were weighed such that a ratio of material quantity is 2:1. Next, these materials were mixed using water as a solvent in a wet manner in a ball mill for 16 hours, and then the mixture was dehydrated, The obtained powder was calcined in the air for two hours at a temperature of 800° C. The calcined product was coarsely pulverized and mixed using water as a solvent in a wet manner in a ball mill for 16 hours, and then was dehydrated, thereby obtaining active material powder. The average particle size of the powder was 0.40 μm. it was confirmed using an X-ray diffractometer that the composition of the prepared powder was Li₂MnO₃.

### (Preparation of Active Material Paste)

Fifteen parts of ethylcellulose as a binder and 65 parts of dihydroterpineol as a solvent were added to 100 parts of the active material powder. Then, the powder was kneaded and dispersed by a triple roll to produce an active material paste.

### (Preparation of Inorganic Solid Electrolyte Sheet)

Li_{3.5}Si_{0.5}P_{0.5}O₄ prepared by a method described below was used as the inorganic solid electrolyte,

Li₂CO₃, SiO₂ and Li₃PO₄ as starting materials, were weighed such that a ratio of material quantity is 2:1:1. Next, these materials were mixed using water as a solvent in a wet manner in a ball mill for 16 hours, and then the mixture was dehydrated. The obtained powder was calcined in the air for two hours at a temperature of 950° C. The calcined product was coarsely pulverized and mixed using water as a solvent in a wet manner in a ball mill for 16 hours, and then was dehydrated, thereby obtaining ion-conductivity inorganic substance powder. The average particle size of the powder was 0.49 μm. It was confirmed using an X-ray diffractometer that the composition of the prepared powder was Li_{3.5}Si_{0.5}P_{0.5}O₄.

Then, 100 parts of ethanol and 200 parts of toluene were added to 100 parts of the powder in a ball mill, and these materials were mixed in a wet manner. After that, 16 parts of a polyvinyl butyral-based binder and 4,8 parts of benzyl butyl phthalate were further mixed into the obtained mixture to prepare an inorganic solid electrolyte paste. The inorganic solid electrolyte paste was formed into a sheet with a PET film as a base material by a doctor blade method to obtain an inorganic solid electrolyte sheet with a thickness of 9 μm.

### (Preparation of Active Material-mixed Current Collector Paste)

As a current collector, Ag/Pd with a weight ratio of 70/30 and Li₂MnO₃ were mixed such that a volume ratio is 60:40. After that, 10 parts of ethylcellulose as a binder and 50 parts of dihydroterpineol as a solvent were added to the obtained mixture. Then, the mixture was kneaded and dispersed by a triple roll to produce a current collector paste. The Ag/Pd with a weight ratio of 70/30 used here is a mixture of Ag powder (with an average particle size of 0.3 μm) and Pd powder (with an average particle size of 1.0 μm).

### (Preparation of Terminal Electrode Paste)

Silver powder, epoxy resin, and a solvent were kneaded and dispersed by a triple roll to produce a thermosetting conductive paste,

These pastes were used to produce an all-solid secondary battery as described below.

### (Preparation of Active Material Unit)

An active material paste with a thickness of 7 μm was formed by screen printing on the foregoing inorganic solid electrolyte sheet. Next, the printed active material paste was dried for 5 to 10 minutes at a temperature of 80 to 100° C. An active material-mixed current collector paste with a thickness of 5 μm was formed by screen printing on the active material paste. Next, the printed current collector paste was dried for 5 to 10 minutes at a temperature of 80 to 100° C. Furthermore, an active material paste with a thickness of 7 μm was formed again by screen printing on the current collector paste. The printed active material paste was dried for 5 to 10 minutes at a temperature of 80 to 100° C. Then, a PET film was separated. Accordingly, sheet of active material unit in which the active material paste, the active material-mixed current collector paste, and the active material paste were printed and dried in this order was obtained on the inorganic solid electrolyte sheet.

### (Preparation of Laminated Body)

Two active material units were laminated with inorganic solid electrolyte interposed therebetween. At that time, these units were laminated so as to be displaced from each other. Specifically, the active material-mixed current collector paste layer of the first active material unit extends only to one end face. On the other hand, the active material-mixed current collector paste layer of the second active material unit extends only to the other face. Inorganic solid electrolyte sheets were laminated on the both sides of the laminated units so that a thickness is 500 μm. After that, the laminated sheets were formed at a temperature of 80° C. and under a pressure of 1000 kgf/cm² [98 MPa], and were cut out to produce laminated blocks. Then, the laminated blocks were subjected to simultaneous sintering to obtain a laminated body. The simultaneous sintering was conducted in such a manner that a temperature increases up to 1000° C. at a temperature increase rate of 200° C./hour in the air, and the temperature was held for two hours. After the sintering, natural cooling was performed.

The battery outer size after the simultaneous sintering was 3.7 mm×3.2 mm×0.35 mm.

### (Step of Forming Terminal Electrode)

A terminal electrode paste was applied to end faces of the laminated body and was thermally hardened at a temperature of 150° C. for 30 minutes to form a pair of terminal electrodes, thereby obtaining an all-solid lithium ion secondary battery.

### Example 2

An all-solid secondary battery was produced in the same manufacturing process as that in Example 1, except that the active material unit was formed by applying only the active material-mixed current collector paste on the inorganic solid electrolyte sheet and drying the same. The active material-mixed current collector electrode of the produced battery has a thickness of 7 μm.

The battery outer size after the simultaneous sintering was 3.7 mm 3.2 mm×0.35 mm.

### (Evaluation of Battery Characteristics)

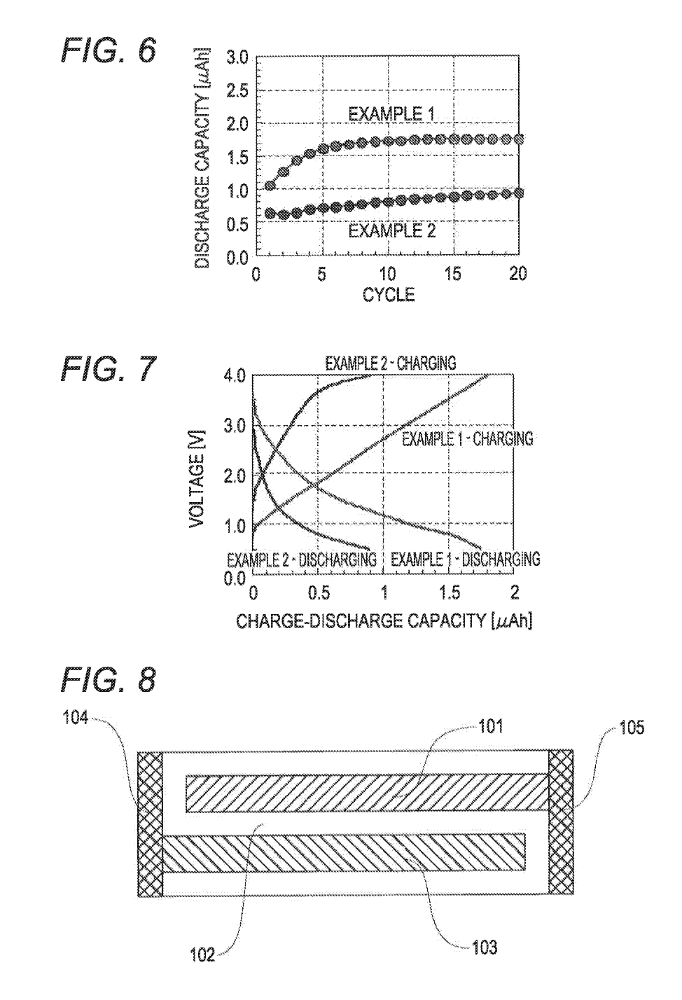

Lead wire was attached to each of the terminal electrodes to conduct a repeated charge-discharge testing. Measurement conditions were as described below. Specifically, the magnitude of current was set to 0.1 μA both on charging and discharging. In addition, the magnitudes of cutoff voltage were set to 4.0 V and 0.5 V on charging and discharging, respectively. FIG. 7 shows test results. From the test results, it was ascertained that the produced nonpolar lithium ion secondary batteries according to the present invention operates properly as batteries in both of Examples 1 and 2. Furthermore, FIG. 6 shows cycle characteristics of the nonpolar batteries produced in Examples 1 and 2. From this graph, it was ascertained that the produced nonpolar batteries can operate properly as repeatedly chargeable and dischargeable secondary batteries in both of Examples 1 and 2, However, the battery in Example 2 exhibited a tendency of increase in discharge capacity due to repeated charging and discharging, whereas the battery in Example 1 exhibited constant discharge capacity after about 10 cycles. The cause for that difference is unknown. However, such a difference may occur between nonpolar batteries having the same structure if the sintering conditions are different. Therefore, the foregoing difference may be caused by a difference in a state of a joint interface on simultaneous sintering.

### (Verification of Nonpolarity)

Twenty batteries in Examples 1 and 2 were subjected to charge-discharge measurement without checking a battery voltage. Each of the batteries exhibited almost the same behaviors as the cycle characteristics shown in FIG. 6. From this, it was ascertained that the all-solid battery of the present invention has no polarity.

### Example 3

The active material found by the inventors of the present application to be usable as an active material for a nonpolar battery can be utilized for not only all-solid secondary batteries but also wet secondary batteries, with excellent battery characteristics. The manufacturing method, the evaluation method, and the evaluation results of the wet battery will be described below.

The foregoing active material, Ketjenblack, and polyvinylidene fluoride were mixed at a weight ratio of 70:25:5. Furthermore, N-methylpyrrolidone was added to the mixture to obtain an active material slip. After that, the active material slip was evenly applied on a stainless foil by a doctor blade method, and was then dried. The active material-applied stainless sheet was punched out by a 14 mm-φ punch. This sheet (hereinafter referred to as “disk sheet electrode”) was subjected to vacuum deaeration drying for 24 hours at a temperature of 120° C., and was weighed precisely in a glove box at a dew point of −65° C. or less. In addition, a stainless foil disk sheet was separately formed by punching out a stainless sheet alone with a diameter of 14 mmφ, and its weight was precisely measured. The weight of the active material applied to the disk sheet electrode was accurately calculated from a difference between the precisely weighed value of the disk sheet and the precisely weighed value of the disk sheet electrode. Accordingly, a wet battery including electrodes formed by the thus obtained disk sheet electrodes, a porous polypropylene separator, a non-woven fabric electrolyte holding sheet, and organic electrolyte in which lithium ions are dissolved (LiPF6 is dissolved by 1 mol/L in an organic solvent with EC:DEC=1:1 vol) was prepared.

The charge-discharge rate of the produced battery was measured with 0.1 C at a charge-discharge testing, and the charge-discharge capacity was measured.

FIG. 5 shows charge-discharge curves and cycle characteristics of the nonpolar wet battery produced in Example 3. Because the wet battery including organic electrolytic solution also included the same Li₂MnO₃ for both electrodes, the wet battery had no polarity. In the battery, Li₂MnO₃ to which a higher voltage was applied by a charge-discharge measurement device caused a lithium &intercalation reaction. On the other hand, Li₂MnO₃ to which a lower voltage was applied caused an intercalation reaction. The battery in Example 3 operated properly as a battery as with the batteries in Examples 1 and 2.

The conventional lithium ion secondary batteries with electrolytic liquid including different active materials for positive and negative electrodes have risks of heat generation, breakage, and the like due to reverse charging. However, the lithium ion secondary battery including the same active material for positive and negative electrodes according to the present invention, even if including liquid electrolyte, is formed by materials with which the active material and current collector on positive and negative electrodes are arranged in symmetry with electrolyte interposed therebetween. Accordingly, it was ascertained that the lithium ion secondary battery according to the present invention has no risk of problems resulting from reverse charging.

### INDUSTRIAL APPLICABILITY

As described in detail, the present invention allows for simplification of the process of manufacturing and the process of mounting the lithium ion secondary battery. Therefore, the present invention contributes significantly to the fields of electronics.

1. A lithium ion secondary battery comprising a laminated body formed by laminating a first electrode layer and a second electrode layer on each other via an electrolytic region, wherein
the first electrode layer and the second electrode layer comprise the same active material, and
the active material is, Li₂MnₓMe₁₋ₓO₃ (Me=Ni, Cu, V, Co, Fe, Ti, Al, Si, or P, and 0.5≦×≦1).

2. The lithium ion secondary battery according to claim 1, wherein a material constituting the electrolytic region is an inorganic solid electrolyte.

3. The lithium ion secondary battery according to claim 3, wherein the inorganic solid electrolyte is ceramic including at least lithium, phosphorus, and silicon.

4. The lithium ion secondary battery according to claim 1, wherein the laminated body is sintered.

5. The lithium ion secondary battery according to claim 1, wherein a material constituting the electrolytic region is liquid electrolyte.

6. The lithium ion secondary battery according to claim 1, wherein a plurality of battery cells including the laminated body is connected in series or series-parallel via a conductor layer.

7. An electronic device using the lithium ion secondary battery according to claim 1 as a power source.

8. An electronic device using the lithium ion secondary battery according to claim 1 as a power storage element.

9. The lithium ion secondary battery according to claim 1, wherein the active material is Li₂MnO₃.

10. The lithium ion secondary battery according to claim 1, wherein each of the first electrode layer and the second electrode layer is an electrode layer selected from the group consisting of an active material layer including only the active material, a mixture layer including the active material and a conductor material, a mixture layer including the active material and solid electrolyte, and a layer including these layers.
